(19) United States
(12) Patent Application Publication
(10) Pub. No.: US 2005/0015648 A1
(43) Pub. Date: Jan. 20, 2005

(54) Disk storage apparatus capable of concurrently processing data streams

(75) Inventors: Fuyuki Tawada, Ome-shi (JP); Yasuhiko Ichikawa, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/812,049

(22) Filed: Mar. 30, 2004

(30) Foreign Application Priority Data
Jun. 30, 2003 (JP) 2003-188794

(51) Int. Cl. H02H 3/05

(52) U.S. Cl. 714/5

(57) ABSTRACT

In a disk storage apparatus which can concurrently process a plurality of data streams specified by a host, it is determined whether an error has occurred in a write operation specified by a write command being executed. If it is determined that an error has occurred, the write command is retried regardless of whether or not the time spent performing the write operation until the present time is within a time limit specified by the write command.

### CROSS-REFERENCE TO RELATED APPLICATIONS

This application is based upon and claims the benefit of priority from prior Japanese Patent Application No. 2003-188794, filed Jun. 30, 2003, the entire contents of which are incorporated herein by reference.

### BACKGROUND OF THE INVENTION

1. Field of the Invention

The present invention relates to a disk storage apparatus capable of concurrently processing a plurality of data streams, and in particular, to a disk storage apparatus suitably used if recording of a data stream and reproduction of a data stream are performed concurrently as well as a method of controlling data streams

2. Description of the Related Art

Hard disk drives (hereinafter referred to as “HDDs”) are well known as disk storage apparatuses using a disk as a storage medium. The storage capacity of the HDDs has recently been increased. Correspondingly, more and more HDDs have been used for audio-visual (AV) applications to record AV data. Furthermore, data recording and reproducing apparatuses comprising an HDD for AV applications, what is called video recorders, have been developed. Many of the video recorders have a function of recording (writing) AV data to the HDD while reproducing (reading) another AV data already recorded in the HDD. The video recorder of this kind, for example, makes it possible to record AV data on a user specified television program while reproducing AV data on another television program. In this case, the AV data recorded in the HDD or reproduced from it is commonly sequential data that is temporally continuous. Such AV data is thus called a data stream (AV stream).

The recent video recorders also have a function of recording a data stream for a user specified television program in an HDD while reproducing each part of the data stream for this program an arbitrary time later than the corresponding recording. Furthermore, video recorders comprising an HDD and a digital versatile disk (DVD) drive (DVD recorder) have recently been developed. The video recorder of this kind makes it possible to record, in the HDD, a data stream recorded in the DVD while reproducing another data stream already recorded in the HDD.

In this manner, a video recorder comprising an HDD for AV applications enables the concurrent performance of recording of a data stream and reproduction of a data stream. However, it is impossible to simultaneously make a plurality of accesses to the HDD. Thus, a host utilizing an HDD for AV applications records or reproduces data streams by sequentially issuing a plurality of write or read commands to the HDD one by one. In this case, while a write or read of data specified by one command is being executed, writes or reads of data specified by subsequent commands must wait.

Data streams must be recorded and reproduced in real time. Thus, write or read commands provided to the HDD by the host are provided with information on time limits. The time limit is the maximum time available for a write or read specified by the corresponding command (that is, a permissible time). Commands (write or read commands) with information on time limits are called commands with time limits.

In the prior art, with an HDD applied to a video recorder, if for example, an error occurs in the execution of a read command with a time limit, a retry is repeated within the time limit. In this case, it is determined whether or not the time required to execute the command exceeds the time limit. It is assumed that in this situation, reproduction of a data stream from a disk and recording of a data stream on this disk are concurrently being performed. It is further assumed that the execution of a read command required to reproduce the data stream (that is, a read operation) is continued by repeating a retry until the time limit is exceeded. In this case, the execution of a write command required to record a data stream (that is, a write operation) must wait. Then, the time limit for the write operation is exceeded before the write operation is completed.

Likewise, if an error occurs in a write operation specified by a write command with a time limit, a retry is also repeated within the time limit. If the retry is repeated until the time limit is exceeded, the write operation is suspended. At this time, if a read command waiting to be executed is present in the HDD, it can be executed. However, since the write operation has been suspended, write data may not be secured.

The status of the concurrent recording or reproduction of data streams varies over time. Jpn. Pat. Appln. KOKAI Publication No. 11-327807 describes a technique of changing a timeout time corresponding to the above time limit, to a relatively long time if only a small number of data streams are concurrently processed. The conventional technique described in this publication can reduce the frequency with which a read or write operation is not completed even after the timeout time has passed.

As described above, with a conventional HDD for AV applications, if an error occurs in the execution of a read command with a time limit, a retry may be repeated until the time limit is exceeded. However, it may be known before a read command is executed that a read operation specified by the read command cannot be completed within the time limit. For example, this is the case in which the time limit exceeds the sum of a seek time required to move a head to a target position (target track) on a disk and a time required to transfer data of a size specified by a read command (a data transfer time). Thus, in the prior art, even if it is known before a read command with a time limit is executed that the command requests a read operation exceeding the basic abilities of the HDD, the read operation may be performed until the time limit is exceeded. In this case, if any write command for recording a data stream is waiting to be executed, then the time limit for a write operation specified by the write command is exceeded before the write operation is executed. In this situation, write data is not secured.

On the other hand, with the conventional technique described in the above publication, if only a small number of data streams are processed concurrently, the time limit (timeout time) is changed to a relatively long time. Thus, this conventional technique can reduce the frequency with which a read or write operation is not completed even after the timeout time has passed. However, this is impossible if a large number of data streams are processed concurrently. In this case, the time limit for this write operation may also be exceeded before the write operation is completed. Furthermore, write data may not be secured.

### BRIEF SUMMARY OF THE INVENTION

According to an embodiment of the present invention, there is provided a disk storage apparatus which can concurrently process a plurality of data streams specified by a host, in which a head reads and writes data from and to a disk. The disk storage apparatus comprises executing means, detecting means, and controlling means. The executing means sequentially executes, in a time series manner, write commands with time limits provided by the host and instructing data streams to be written and read commands with time limits provided by the host and instructing data streams to be read. The detecting means detects that an error has occurred in a write operation specified by any of the write commands. The controlling means controls the executing means if the detecting means detects that an error has occurred in the write operation specified by any of the write commands. That is, the controlling means causes the executing means to continue the write operation regardless of whether or not the time spent performing the write operation until the present time is within the time limit specified by the write command.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of a hard disk drive for AV applications according an embodiment of the present invention;

FIG. 2 is a diagram showing the format of a disk 111 in FIG. 1;

FIG. 3 is a diagram showing an example of a data structure in a seek time table 123a in FIG. 1;

FIG. 4 is a diagram showing an example of a data structure in a transfer rate table 123b in FIG. 1;

FIG. 5 is a flowchart showing the procedure of a write operation according to the embodiment; and

FIG. 6 is a flowchart showing the procedure of a read operation according to the embodiment.

### DETAILED DESCRIPTION OF THE INVENTION

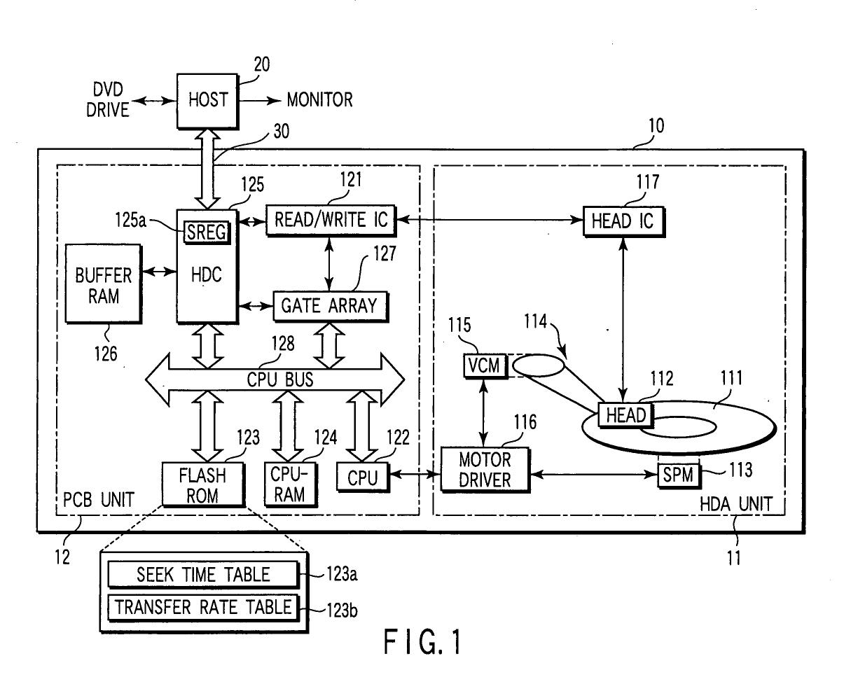

With reference to the drawings, description will be given of an embodiment in which the present invention is applied to a hard disk drive for AV applications. FIG. 1 is a block diagram showing the configuration of a hard disk drive (hereinafter referred to as an HDD) 10 for AV applications according to this embodiment. The HDD 10 is assumed to be provided in a data recording and reproducing apparatus (hereinafter referred to as a video recorder) utilizing the HDD 10 as an HDD for AV applications. The HDD 10 is roughly composed of a head disk assembly unit (hereinafter referred to as an HDA unit) 11 and a printed circuit board unit (hereinafter referred to as a PCB unit) 12.

The HDA unit 11 includes a disk (magnetic disk) 111, a head (magnetic head) 112, a spindle motor (hereinafter referred to as an SPM) 113, an actuator 114, a voice coil motor (hereinafter referred to as a VCM) 115, a motor driver 116, and a head IC 117. The disk 111 is a recording medium having two disk surfaces: an upper and lower disk surfaces. At least one of the two disk surfaces of the disk 111 constitutes a recording surface on which data is magnetically recorded. The head 112 is arranged in association with one of the disk surfaces of the disk 111 which constitutes the recording surface. In FIG. 1, for the convenience of illustration, the single head 112 is shown. However, in general, the two disk surfaces of the disk constitute respective recording surfaces, with heads arranged in association with the respective disk surfaces. Furthermore, for the configuration in FIG. 1, the HDD comprising the single disk 111 is assumed. However, a plurality of disks 111 may be stacked in the HDD.

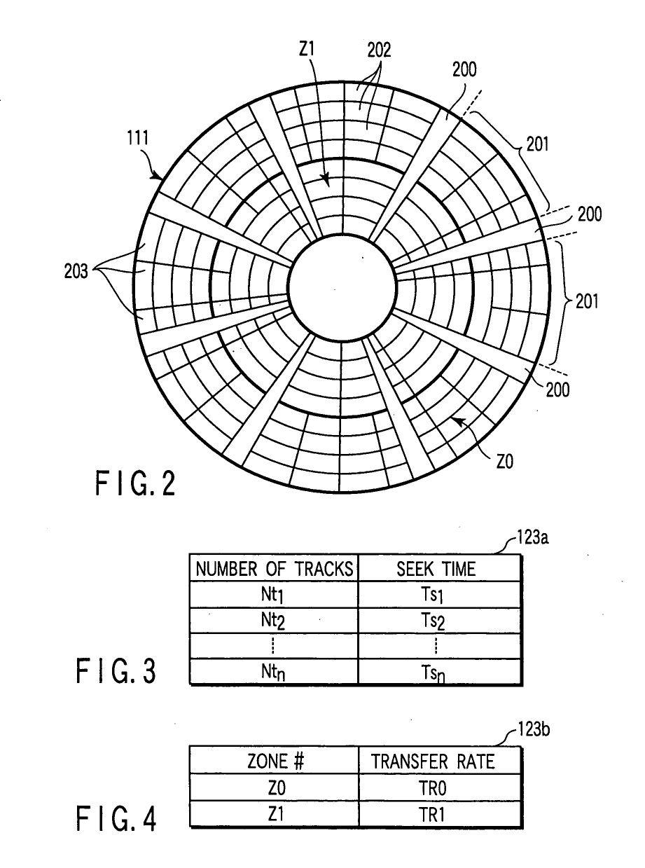

FIG. 2 shows the format of the disk 111. As shown in FIG. 2, a plurality of servo areas 200 are arranged discretely at equal intervals in a circumferential direction of the disk 111 and radially in a radial direction of the disk 111. Servo data is prerecorded in each servo area 200. The servo data contains positional information required to position the head 112 at a target position on the disk 111. In the recording surface of the disk 111, the area between the adjacent servo areas 200 is used as a data area. A large number of concentric tracks (data tracks) 202 are arranged on the recording surface of the disk 111. In the data area 201, a plurality of data sectors 203 are provided in each track 202.

A recording format called CDR (Constant Density Recording) is applied to the disk 111. The recording surface of the disk 111 to which the CDR format is applied is manageably divided into a plurality of zones in the radial direction of the disk 111. In the example shown in FIG. 2, for the convenience of illustration, the recording surface of the disk 111 is manageably divided into two zones Z0 and Z1. The zones Z0 and Z1 have different numbers of data sectors 203 per track (cylinder). The number of data sectors 203 per track (cylinder) is set to be larger on the outer peripheral zone of the disk 11. This setting is employed in order to increase the formatting efficiency of the disk 111 utilizing effectively the outer peripheral areas of the disk, in which the tracks (cylinders) have a larger physical circumferential length. As is well known, when data is read from or written to the disk 111, data transfer rate is higher in the outer peripheral zone of the disk 111.

Referring back to FIG. 1, the head 112 is used to read data from the disk 111 (data reproduction) and write data to the disk 111 (data recording). The SPM 113 rotates the disk 111 at a high speed. The head 112 is attached to the tip of the actuator 114. The actuator 114 has a VCM 115 acting as a driving source for the actuator 114. The actuator 114 is driven by the VCM 115 to move the head 112 in the radial direction of the disk 111. The SPM 113 and the VCM 115 are driven by respective driving currents (an SPM current and a VCM current) supplied by the motor driver 116. The motor driver 116 supplies the SPM 113 with an amount of SPM current specified by a CPU 122, in order to rotate the SPM 113 at a rated speed. The motor driver 116 also supplies the VCM 115 with an amount of VCM current specified by the CPU 122, in order to position the head 112 at the target position on the disk 111. The head 112 is connected to a head IC (head amplifier circuit) 117. The head IC 117 includes a read amplifier that amplifies a read signal read by the head 112 and a write amplifier that converts write data into a write current.

The PCB unit 12 includes a read/write IC (read/write channel) 121, a CPU 122, a flash ROM 123, a CPU-RAM 124, a disk controller (hereinafter referred to as an HDC) 125, a buffer RAM 126, a gate array 127, and a CPU bus 128. These elements 121 to 128 are mounted on a printed circuit board (PCB; not shown). The CPU 122, the flash ROM 123, the CPU-RAM 124, the HDC 125, and the gate array 127 are interconnected by the CPU bus 128.

The read/write IC 121 is a signal processing device. The read/write IC 121 performs various signal processes including an analog-to-digital conversion of a read signal, encoding of write data, and decoding of read data.

The CPU 122 provides, in a time division manner, control of the elements in the HDD 10 other than the motor driver 116 and control of the motor driver 116 required to position the disk 111 at the target position on the disk 111. The control provided by the CPU 122 includes read/write control performed by the HDC 125 in accordance with a read or write command from the host 20. The host 20 is a main controller for a video recorder comprising the HDD 10. The host 20 utilizes the HDD 10 as an HDD for AV applications. The host 20 issues a string of write or read commands to the HDD 10 which commands correspond to recording or reproduction of a data stream specified by a user, in order to perform the recording or reproduction. The specification of the recording or reproduction of the data stream is transmitted to the host 20 by input equipment (not shown) connected to the host by wire or radio, when the user operates the input equipment. The input equipment is, for example, a remote controller.

The flash ROM 123 is a rewritable nonvolatile memory that stores programs (control programs) to be executed by the CPU 122. Some storage areas of the flash ROM 123 are used to store a seek time table 123a and a transfer rate table 123b. The seek time table 123a pre-stores the time required to move the head 112 to a target track (that is, a seek time), using the number of tracks to pass before reaching the target, as a parameter. The transfer rate table 123b pre-stores information on the data transfer rate for each zone of the disk 111. the CPU-RAM 124 is used as a work area used by the CPU 122 and an area in which variables used by the CPU 122 are stored.

FIG. 3 shows an example of a data structure in the seek time table 123a. As shown in this figure, the table 123a stores information on a seek time Tsi for each predefined number of tracks Nti (i=1, 2, . . . n). The seek time Tsi indicates the time required to move the head 112 by an amount equal to the number of tracks Nti, in the radial direction of the disk 111. That is, the seek time table 123a stores information indicative of the correspondence between the number of tracks and the seek time. The relationship between the number of tracks and the seek time varies depending on whether the head 112 moves toward the inner or outer periphery of the disk 111. Thus, information indicative of the correspondence between the number of tracks and the seek time may be stored in the seek time table 123a for each direction in which the head 112 is moved.

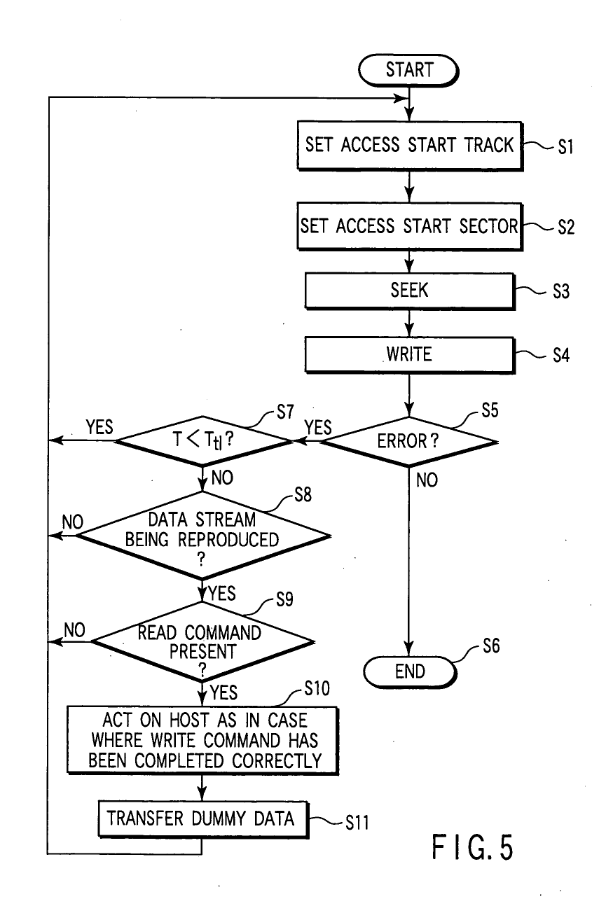

FIG. 4 shows an example of a data structure in the transfer rate table 123b. As shown in this figure, the table 123 stores, for each of the zones Z0 and Z1, information on data transfer rates TR0 and TR1 used to read data from the zone Z0 or Z1 or write data to the zone Z0 or Z1.

The HDC 125 is connected not only to the CPU bus 128 but also to the read/write IC 121, the buffer RAM 126, and the gate array 127. The gate array 127 generates various signals required to control the HDD 10. The HDC 125 is also connected to the host 20 via a host interface 30. The HDC 125 and the gate array 127 are controlled using control registers (not shown). The control registers are assigned to some areas of an address space for the CPU 122. The CPU 122 performs reads from and writes to these areas to control the corresponding HDC 125 or the gate array 127.

The HDC 125 receives commands (read/write commands and the like) transferred by the host 20 and controls the data transfer between the host 20 and the HDC 125. The HDC 125 also controls the data transfer between the disk 111 and the HDC 125 and a buffer control function of controlling the buffer RAM 126. The HDC 125 has a status register (SREG) 125a.

When the host 20 executes a write command, data (write data) transferred by the host 20 to the HDC 125 is temporarily stored in the buffer RAM 126. The write data stored in the buffer RAM 126 is transferred by the HDC 125 to the read/write IC 121 in accordance with a control signal from the gate array 127. The read/write IC 121 encodes the write data transferred by the HDC 125 and outputs the encoded write data to the head IC 117. The encoded write data output to the head IC 117 is converted by the head IC 117 into a write signal. The data converted into the write signal is written by the head 12 in the area on the disk 11 specified by the write command.

On the other hand, when a read command from the host 20 is executed, the head 112 reads a data signal recorded in the area on the disk 111 specified by the read command. The head IC 117 amplifies the signal (read signal) read by the head 112. The read signal amplified by the head IC 117 is decoded by the read/write IC 121. The HDC 125 processes the data decoded by the read/write IC 121, in accordance with a control signal from the gate array 127, to generate data (read data) to be transferred to the host 20. The data is stored in the buffer RAM 126 and transferred by the HDC 125 to the host 20.

Now, a sequential description will be given of operations performed by the HDD 10 in FIG. 1; separate descriptions will be given of a write operation in accordance with a write command and a read operation in accordance with a read command. It is assumed that the video recorder is set for both modes, a first and second modes. In the first mode, a data stream for a user specified television program (hereinafter referred to as a first data stream) is recorded in the HDD 10. In the second mode, a user specified data stream already recorded in the HDD 10 (hereinafter referred to as a second data stream) is reproduced from the HDD 10.

In this state, the host 20 sequentially issues a string of write commands with time limits required to record the first data stream, to the HDD 10. Concurrently, the host 20 sequentially issues a string of read commands with time limits required to reproduce the second data stream. the HDC 125 in the HDD 10 receives the commands issued by the host 20. The commands received by the HDC 125 are queued by the HDC 125 in the order of the reception in a queue buffer provided in the buffer RAM 126. The CPU 122 dequeues and executes the commands in the queue buffer, one by one in the order of reception.

First, with reference to the flowchart in FIG. 5, description will be given of a write operation performed in the HDD 10. It is assumed that the CPU 122 in the HDD 10 starts executing a write command with a time limit provided by the host 20 to the HDD 10 via the host interface 30. In this case, on the basis of an access start address (logical address) specified by the write command, the CPU 122 determines an access (write) start track (target track) and an access (write) start sector (target sector) on the disk 111. The CPU 122 sets the determined access start track and access start sector in the corresponding control registers of the HDC 125 (steps S1 and S2).

Then, the CPU 122 provides seek control that moves the head 112 (which is attacked to the tip of the actuator 114) from the present position to the access start track (step S3). In the seek control, the motor driver 116 is controlled in order to drive the VCM 115. The seek control is provided by the CPU 122 on the basis of positional information contained in servo data every time the head 112 reads the servo data from the servo area 200 on the disk 111. On detecting that the head 112 has reached the access start track on the basis of the positional information read from the head 112, the CPU 122 determines that the seek control (seek operation) has been completed. In this case, the CPU 122 causes the HDC 125 to perform a write operation required to sequentially write the data transferred by the host 20 to the appropriate sectors, sector by sector starting with the previously set access start sector in the previously set access start track (step S4). This write operation is performed on an area corresponding to a data size (the number of sectors) specified by the write command, the area starting with the access start sector.

If the HDC 125 does not detect any errors in the write operation (data write) in accordance with the write command (step S5), the CPU 122 completes execution of this write command (step S6). In this case, if any waiting commands are in the queue buffer, the CPU 122 takes the most previously queued command at that point out of the queue buffer and executes it. At this time, the CPU 122 sets, in the status register 125a in the HDC 125, a status indicating that the execution of the preceding command (in this case, the write command) has been completed correctly. The contents of the status register 125a can be read from the host 20 via the host interface 30. Accordingly, the host 20 can recognize the result of the execution of the command in the HDD 10 by reading the contents of the status register 125a in the HDC 125.

On the other hand, if the HDC 125 detects an error in the data write in accordance with the write command (step S5), the CPU 122 proceeds to step S7. At step S7, the CPU 122 determines whether or not the time T spent executing the write command until the present time is within a time limit Ttl. Here, the time limit Ttl is indicated by the time limit information provided to the write command. If the execution time T for the write command does not exceed the time limit Ttl (step S7), the CPU 122 returns to step S1 to retry this command. In contrast, if the execution time T for the write command exceeds the time limit Ttl, the CPU 122 proceeds to step S8. At step S8, the CPU 122 determines whether or not reproduction of a data stream is being performed concurrently with recording of a data stream.

Even if the execution time T for the write command exceeds the time limit Ttl (step S7), if no data streams are being reproduced (step S8), the CPU 122 determines that the write operation specified by the write command can be continued. In this case, the CPU 122 returns to step S1 to retry the write command. On the other hand, if any data stream is being reproduced (step S8), the CPU 122 determines whether or not any read commands are in the queue buffer (step S9). Even if a process for reproducing a data stream is being performed (step S8), if no read commands are in the queue buffer (step S9), the CPU 122 determines that the write operation specified by the write command can be continued. In this case, the CPU 122 returns to step S1 to retry the write command. Thus, in the present embodiment, even if no write command can be completed within the time limit Ttl, if no data streams are being reproduced, this write command is retried. Likewise, even if no write command can be completed within the time limit Ttl and any data stream is being reproduced, if no read commands are waiting to be executed, this write command is retried.

On the other hand, if any data stream is being reproduced (step S8) and any read commands are in the queue buffer (step S9), the CPU 122 determines that the write command cannot be retried. In this case, the CPU 122 acts on the host 20 as in the case where the write command that failed to be completed within the time limit Ttl has been completed correctly (step S10). Specifically, the CPU 122 sets a dummy status in the status register 125a in the HDC 125, the dummy status indicating a write command that failed to be completed within the time limit Ttl has been completed correctly. This operation of the CPU 122 is equivalent to forcing the CPU 122 to recognize (notifying the CPU 122) that the execution of the write command has been completed correctly.

Then, the CPU 122 takes the most previously queued read command out of the queue buffer. Then, instead of executing the dequeued read command, the CPU 122 allows the HDC 125 to transfer a size of predefined dummy data specified by this command to the host 20 (step S11). This forces the execution of the dequeued command to be completed. This is equivalent to executing the dequeued read command in a short time. The CPU 122 then returns to step S1 to retry the write command, which failed to be completed within the time limit Ttl.

Thus, in the present embodiment, in a particular state in which a retry exceeding the time limit Ttl results from the execution of a write command with a time limit, the HDD 10 acts on the host 20 as in the case where the execution of this write command has been completed correctly. That is, the HDD 10 formally completes the execution of the write command. On the other hand, in the HDD 10, the write operation specified by this write command is continuously executed. Thus, the HDC 10 can secure write data to ensure the quality of recorded data even if the above particular state occurs. In the present embodiment, when the above particular state occurs, even if a process for reproducing a stream is being performed and any read command is waiting to be executed, the execution of the write command is given priority. In this case, read data is not secured, thus degrading the quality of reproduced data. However, the degradation of the quality of reproduced data is temporary. Furthermore, instead of executing the read command, the HDD 10 transfers dummy data to the host 20. Consequently, the time required to execute the read command can be used to continue executing the write command. This minimizes adverse effects resulting from the priority given to the write command.

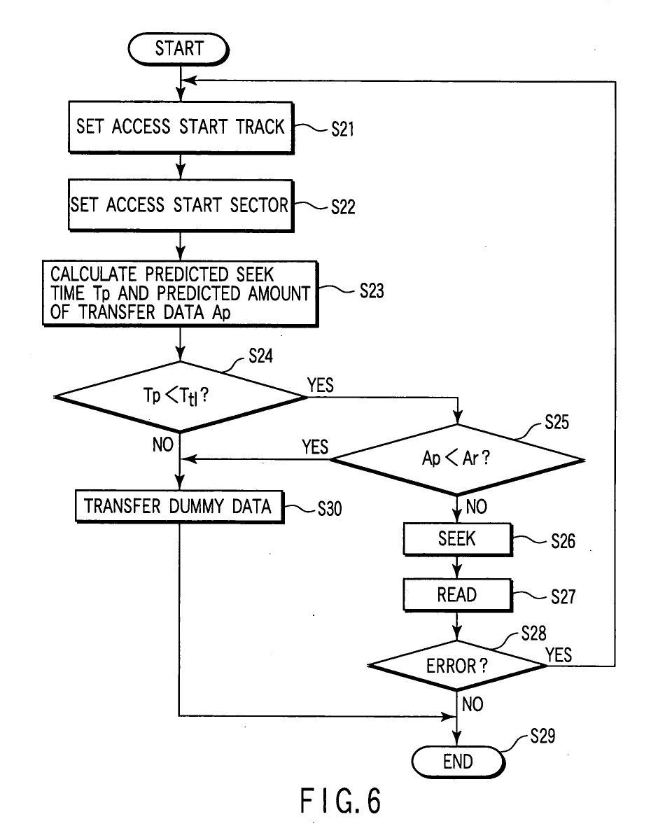

Now, with reference to the flowchart in FIG. 6, description will be given of a read operation performed in the HDD 10. It is assumed that the CPU 122 in the HDD 10 starts executing a read command with a time limit provided by the host 20. In this case, on the basis of an access start address specified by the read command, the CPU 122 determines an access (read) start track and an access (read) start sector on the disk 111. The CPU 122 sets the determined access start track and access start sector in the corresponding control registers of the HDC 125 (steps S21 and S22).

Then, the CPU 122 calculates a predicted seek time Tp and the predicted amount of transfer data Ap (step S23). The predicted seek time Tp represents the time required for an operation of moving the head 112 to the present position to the access start track (target track) (that is, a seek operation). On the other hand, the predicted amount of transfer data Ap represents the amount of data (data size) that can be read, within a time (Ttl-Tp), from an area starting with the access start sector on the access start track. The time (Ttl-Tp) is obtained by subtracting the predicted seek time Tp from the time limit Ttl.

On the basis of the number of tracks (number of cylinders) Nt and the seek time table 123a, the predicted seek time Tp is calculated as follows. Here, the number of tracks Nt corresponds to the tracks from the one corresponding to the present position up to the access start track. That is, the number of tracks Nt corresponds to the distance that the head is moved during a seek operation (this number will hereinafter be referred to as the number of seek tracks). First, the CPU 122 searches the seek time table 123a for the number of tracks Nti which is smaller than but closest to the value Nt. Further the CPU 122 searches the seek time table 123a for the number of tracks Nti+1 which is larger than but closest to the value Nt. Then, the CPU 122 takes information out of the seek time table 123a, the information relating to the numbers of tracks Nti and Nti+1 and associated seek times Tsi and Tsi+1. The CPU 122 calculates the seek time Ts corresponding to the number of seek tracks Nt by an interpolating process using the seek time Tsi and Tsi+1. The CPU 122 determines the calculated seek time Ts to be the predicted seek time Tp. If information indicative of the number of tracks corresponding to the value Nt is stored in the seek time table 123a, the seek time Ts associated with the value Nt is used as the predicted seek time Tp.

On the basis of the zone Z1 to which the access start track belongs and the transfer rate table 123b, the predicted amount of transfer data Ap is calculated as follows. First, the CPU 122 reads in formation on a data transfer rate TR1 inherent in the zone Z1, from the transfer rate table 123b. The value TRi indicates a data transfer rate used when a read is performed on the zone Z1, on the basis of the amount of data (for example, the number of sectors) that can be transferred per unit time. The CPU 122 multiplies the value TRi by the time (Ttl-Tp) to calculate the amount of data that can be transferred within the (Ttl-Tp), as the predicted amount of transfer data Ap (=TRi(Ttl−Tp)). In this connection, if the CDR format is not applied to the disk 111, the data transfer rate is the same for all the tracks on the disk 111. In this case, the same data transfer rate TR may always be applied.

Once the CPU 122 calculates the predicted seek time Tp and the predicted amount of transfer data Ap (step S23), it proceeds to step S24. At step S24, the CPU 122 determines whether or not the predicted seek time Tp is within the time limit Ttl, indicated by the time limit information provided to the read command. That is, the CPU 122 determines (predicts) whether or not it is possible to complete, within the time limit Ttl, a seek operation of moving the head 112 from the present position to the access start track.

If it is predictable that the seek operation can be completed within the time limit Ttl (step S24), the CPU 122 proceeds to step S25. At step S25, the CPU 122 determines whether or not the predicted amount of transfer data Ap is smaller than the amount of transfer data (the requested amount of transfer data) Ar specified by the read command to be executed. That is, the CPU 122 determines (predicts) whether or not the amount of data (data size) requested by the read command can be transferred within the time (Ttl−Tp). If the requested amount of data can be transferred within the time (Ttl−Tp), the CPU 122 determines that conditions for executing the read command have been established. In this case, to perform the read operation specified by the read command, the CPU 122 provides seek control that moves the head 112 from the present position to the access start track (step S26).

Once the head 112 reaches the access start track, the CPU 122 determines that the seek control (seek operation) has been completed. In this case, the CPU 122 causes the HDC 125 to perform a read operation for sequentially reading data, sector by sector, from an area corresponding to a data size (the number of sectors) specified by the read command (step S27). The area starts with the access start sector on the access start track set in steps S21 and S22, described above.

If the HDC 125 detects an error in the data read in accordance with the read command (step S28), the CPU 122 returns to step S21 to retry this command. Then, during the retry of the read command, it is determined again whether or not the retry of this command can be completed within the time limit Ttl (step S24 or S25).

On the other hand, if no errors are detected in the data read in accordance with the read command, that is, all the data corresponding to the data size specified by the read command has been read correctly (step S28), the CPU 122 ends execution of this command (step S29). In this case, if any waiting commands are in the queue buffer, the CPU 122 takes the most previously queued command at that point out of the queue buffer and executes it. At this time, the CPU 122 sets, in the status register 125a in the HDC 125, a status indicating that the execution of the preceding command (in this case, the read command) has been completed correctly. The host 20 can refer to the status set in the status register 125a. The host 20 can refer to this status to recognize that the execution of the corresponding command has been completed correctly.

On the other hand, if it is predicted that the seek operation cannot be completed within the time limit Ttl (step S24), the CPU 122 determines that the conditions for executing the read command are not established. In this case, instead of executing the read command, the CPU 122 allows the HDC 125 to transfer a size of predefined dummy data specified by this command to the host 20 (step S30). This forces the execution of the read command to be completed. This is equivalent to executing, in a short time, the read command for which it is known that a seek operation cannot be completed within the time limit. At this time, if any waiting commands are in the queue buffer, the CPU 122 takes the most previously queued command at that point out of the queue buffer and executes it. Then, although the CPU 122 has not executed the preceding read command, it sets, in the status register 125a in the HDC 125, a dummy status indicating that the execution of this command has been completed correctly.

If it is predicted that the amount of data requested by the read command cannot be transferred (read) within the time (Ttl−Tp) (step S25), the CPU 122 also determines that the conditions for executing the read command are not established. Also in this case, the CPU 122 performs step S30 to allow the HDC 125 to transfer dummy data to the host 20.

Thus, in the present embodiment, it is predicted beforehand whether a read command with a time limit can be executed in the HDD 10 within the time limit Ttl. This prediction is made taking into account the seek time, known as the basic ability of the HDD 10, and the amount of data requested by the read command (the requested amount of transfer data). Then, if the read command requests a read operation exceeding the basic ability of the HDD 10, the HDD 10 transfers dummy data to the host 20 instead of executing this command. Thus, even though a read command is known to request a read operation exceeding the time limit Ttl, the present embodiment can avoid executing this read command needlessly. Furthermore, in the present embodiment, owing to the avoidance of such a needless operation, if concurrently with recording of a data stream, the same or another data stream is reproduced, a write command for recording the data stream can be given execution priority.

In the above embodiment, the HDD is utilized in the video recorder for AV applications. However, the HDD can be utilized to record and reproduce data streams in a personal computer. Furthermore, in the description of the above embodiment, the present invention is applied to the HDD (Hard Disk Drive). However, the present invention is applicable to disk storage apparatuses other than the HDD, such as an optical disk drive and a magneto-optical disk drive provided that they are capable of reading and writing.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A disk storage apparatus which can concurrently process a plurality of data streams specified by a host, in which a head reads and writes data from and to a disk, the disk storage apparatus comprising:
means for sequentially executing, in accordance with a time series, write commands with time limits provided by the host and instructing a data stream to be written and read commands with time limits provided by the host and instructing a data stream to be read;
means for detecting that an error has occurred in a write operation specified by any of the write commands; and
means for controlling the executing means, the controlling means operating if the detecting means detects that an error has occurred in the write operation specified by any of the write commands, to cause the executing means to continue the write operation regardless of whether or not a time spent performing the write operation until the present time is within the time limit specified by the write command.

2. The disk storage apparatus according to claim 1, further comprising:
means for determining whether the time spent performing the write operation specified by the write command, until the present time, is within the time limit specified by the write command when the detecting means detects that an error has occurred in the write operation; and
means for transferring predefined dummy data to the host, the transferring means operating when the time spent performing the write operation is determined to exceed the time limit and there is a read command waiting to be executed, to transfer the dummy data to the host as read data requested by the read command instead of executing the read command.

3. The disk storage apparatus according to claim 2, wherein the control means includes:
means for determining whether a data stream is being reproduced when it is determined that the time spent performing the write operation exceeds the time limit;
means for determining whether there is a read command waiting to be executed when it is determined that a data stream is being reproduced; and
means for activating the transferring means when it is determined that there is a read command waiting to be executed.

4. The disk storage apparatus according to claim 2, further comprising means for acting on the host as in a case where the write command has been completed correctly, when the time spent performing the write operation is determined to exceed the time limit.

5. The disk storage apparatus according to claim 4, further comprising a status register which holds a status indicative of a result of execution of the command by the executing means and which can be referred to by the host, and wherein the acting means sets, in the status register, a dummy status indicating that execution of the write command has been completed correctly.

6. The disk storage apparatus according to claim 1, further comprising means for predicting whether execution of the read command with the time limit is completed within the time limit specified by the read command, before the execution of the read command is started, and wherein if the predicting means predicts that the execution of the read command is not completed within the time limit, the controlling means forces completion of the execution of the read command by the executing means.

7. The disk storage apparatus according to claim 6, wherein if the predicting means predicts that the execution of the read command is not completed within the time limit, the transferring means transfers predefined dummy data to the host as read data requested by the read command instead of executing the read command.

8. The disk storage apparatus according to claim 6, wherein the predicting means predicts whether execution of the read command with the time limit is completed within the time limit specified by the read command, on the basis of a position of an access start track on the disk specified by the read command, a present position of the head, and the amount of data to be read, specified by the read command, and the execution of the read command includes a seek operation of moving the head to the access start track and an operation of reading an amount of data specified by the read command from the disk after the seek operation has been completed.

9. The disk storage apparatus according to claim 8, wherein the predicting means includes:
means for predicting a seek time required to move the head to the access start track on the disk specified by the read command;
means for predicting the amount of data which can be read from an area starting with an access start sector on the access start track specified by the read command, within a remaining time obtained by subtracting the seek time predicted by the means for predicting the seek time from the time limit specified by the read command; and
means for determining whether the execution of the read command is completed within the time limit, the determining means determining that the execution of the read command is completed within the time limit when the seek time predicted by the means for predicting the seek time is within the time limit and when the amount of data predicted by the means for predicting the amount of data exceeds the amount of data to be read which amount is specified by the read command, and otherwise determining that the execution of the read command is not completed within the time limit.

10. The disk storage apparatus according to claim 9, further comprising a seek time table indicating, for each predefined number of tracks, a correspondence between the number of tracks and a seek time required to move the head by an amount corresponding to the number of tracks, wherein the means for predicting the seek time predicts the seek time required to move the head by the amount corresponding to the number of tracks, on the basis of the number of tracks from one corresponding to the present position of the head up to the access start track on the disk specified by the read command as well as the seek time table.

11. The disk storage apparatus according to claim 6, wherein:
the detecting means also detects that an error has occurred in a read operation specified by the read command;
if the detecting means detects that an error has occurred in the read operation specified by the read command, the predicting means predicts again whether execution of the read command is completed within the time limit specified by the read command; and
if it is determined in the second prediction by the predicting means that the execution of the read command is completed within the time limit, the controlling means causes the executing means to continue executing the read command.

12. A method of controlling data streams, the method being applied to a disk storage apparatus which can concurrently process a plurality of data streams specified by a host, the method comprising:
sequentially executing, in accordance with a time series, write commands with time limits provided by the host and instructing a data stream to be written and read commands with time limits provided by the host and instructing a data stream to be read;
detecting that an error has occurred in a write operation specified by any of the write commands; and
controlling a retry of the write command so that if it is detected that an error has occurred in the write operation specified by any of the write commands, the retry of the write command is executed regardless of whether a time spent performing the write operation until the present time is within the time limit specified by the write command.

13. The method according to claim 12, further comprising:
determining whether the time spent performing the write operation specified by the write command, until the present time, is within the time limit specified by the write command when it is detected that an error has occurred in the write operation; and
transferring predefined dummy data to the host so that when the time spent performing the write operation is determined to exceed the time limit and there is a read command waiting to be executed, the dummy data is transferred to the host as read data requested by the read command instead of executing the read command; and
wherein when the time spent performing the write operation is determined to exceed the time limit and there is a read command waiting to be executed, the write command is retried after the dummy data has been transferred to the host.
